(19) United States
(12) Patent Application Publication
(10) Pub. No.: US 2005/0002139 A1
(43) Pub. Date: Jan. 6, 2005

(54) Electrostatic discharge clamp circuit

(76) Inventors: Ta-Hsun Yeh, Hsin Chu City (TW); Chao-Cheng Lee, Science-Based Industrial Park (TW); Tay-Her Tsaur, Tai Nan City (TW)

Correspondence Address: BIRCH STEWART KOLASCH & BIRCH, PO BOX 747, FALLS CHURCH, VA, 22040-0747, US

(21) Appl. No.: 10/868,954

(22) Filed: Jun. 17, 2004

(30) Foreign Application Priority Data
Jul. 2, 2003 (TW) 092118102

(51) Int. Cl. H02H 9/08

(52) U.S. Cl. 361/43

(57) ABSTRACT

An ESD clamp circuit includes an ESD detecting unit and a discharge circuit with a longitudinal BJT. The longitudinal BJT is formed on a P-type substrate and includes a deep N-well formed on the P-type substrate, a P-well formed on parts of the deep N-well, a N-well formed on the deep N-well surrounding the P-well, a first N+ region formed on parts of the P-well and electrically coupled to a first voltage, a P+ region formed on the P-well surrounding the first N+ region and electrically coupled to a trigger signal, and a second N+ region formed on the N-well and electrically coupled to a second voltage. In the structure of the longitudinal BJT, the leakage current can be decreased, the current gain can be increased, and the dimension of the ESD clamp circuit can be reduced.

This application claims the benefit of Taiwan application Serial No. 092118102, filed Jul. 2, 2003.

### BACKGROUND OF THE INVENTION

1. Field of the Invention

The invention relates to an ElectroStatic Discharge (hereinafter called ESD) clamp circuit, and more particularly to an ESD clamp circuit using a deep N-well structure to form a longitudinal BJT (bipolar junction transistor) for electrostatic discharge.

2. Description of the Related Art

In order to constitute a high circuit-integration density and achieve desired functions, a metal-oxide-semiconductor field-effect transistor (MOSFET) with reduced size has been used in the advanced integrated circuit (IC) technology. However, in order to satisfy the demand of the constant field scaling, a power supply voltage is also scaled down in some IC technology. Hence, the computer architecture needs an interface to connect semiconductor chips or sub-systems having different power supply voltages. Owing to the hybrid power supply voltages, the I/O circuit of the interface between chips must have the functions of avoiding the overstress and the improper current leakage path. The ESD protection circuit also has to satisfy the same interface status and limitation.

FIG. 1 illustrates an architecture diagram of an integrated circuit having an ESD clamp circuit. Referring to FIG. 1, the conventional integrated circuit 10 includes an input pad 11, an output pad 13, an internal circuit 12, an input pad clamp circuit 14, an output pad clamp circuit 15, a discharge circuit 16, and an ESD detecting unit 17. The internal circuit 12, the input pad clamp circuit 14, the output pad clamp circuit 15, the discharge circuit 16, and the ESD detecting unit 17 are coupled between the power supply voltages VDD and VSS. The input pad clamp circuit 14 typically includes two diodes Dp1 and Dn1 coupled in series, and a resistor R1. The input pad 11 is coupled to the series connected diodes Dp1 and Dn1 and the internal circuit 12 through the resistor R1. The output pad clamp circuit 15 typically includes a PMOS transistor, a NMOS transistor, and two diodes Dp2 and Dn2.

The discharge circuit 16 and the ESD detecting unit 17 are employed to protect the internal circuit 12 from the damage of the electrostatic charges. Typically, the discharge circuit 16 includes a NMOS transistor 161 to bypass the electrostatic charge current. That is, when there are electrostatic charges surged over the integrated circuit 10 through the pad, the voltage sources (VDD, VSS), and the like, the ESD detecting unit 17 generates a trigger signal VG with higher voltage to trigger the discharge circuit 16 to bypass the electrostatic charge current without damaging the internal circuit 12.

FIG. 2 shows a cross-sectional view of the NMOS transistor of the discharge circuit. As shown in FIG. 2, the NMOS transistor 161 of the typical discharge circuit 16 is formed on the P-type substrate 162. Hence, the electrostatic charge current IESD of the discharge circuit 16 flows from the positive power supply voltage VDD to the NMOS transistor 161 through the drain 163, flows out of the source 164 of the NMOS transistor 161, and then drained through the negative power supply voltage VSS, wherein the NMOS transistor 161 is triggered at the gate 165 by the trigger signal VG. The typical NMOS transistor 161 has a low current gain and has to be designed to have large area so as to quickly bypass the electrostatic charge current. This design, however, has the troubles of incapability of uniform turn on, the poor reliability, and the larger leakage current.

### SUMMARY OF THE INVENTION

In view of the above-mentioned problems, one of the objects of the invention is to provide an ESD clamp circuit for bypassing the electrostatic charge current using a longitudinal BJT constituted on a deep N-well.

Another object of the invention is to provide an ESD clamp circuit with a high current gain.

Another object of the invention is to provide an ESD clamp circuit using a longitudinal BJT. The longitudinal BJT can avoid the troubles of incapability of uniform turn on, or/and the poor reliability.

Another object of the invention is to provide an ESD clamp circuit for reducing a leakage current using a longitudinal BJT constituted on a deep N-well.

To achieve the above-mentioned objects, the ESD clamp circuit of the invention includes an ESD detecting unit and a longitudinal BJT. In an embodiment, the longitudinal BJT is a longitudinal NPN BJT. The longitudinal NPN BJT is formed on a P-type substrate and includes a deep N-well formed on the P-type substrate, a P-well formed on parts of the deep N-well, a N-well formed on the deep N-well surrounding the P-well, a first heavily doped N-type region (N+) formed on parts of the P-well and electrically coupled to a first voltage, a heavily doped P-type region (P+) formed on the P-well surrounding the first heavily doped N-type region and electrically coupled to a trigger signal, and a second heavily doped N-type region formed on the N-well and electrically coupled to a second voltage.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates an architecture diagram of an integrated circuit having an ESD clamp circuit;

FIG. 2 shows a cross-sectional view of a NPN BJT in a twin well of the conventional discharge circuit;

FIG. 3 illustrates an embodiment of an ESD clamp circuit of the invention having a deep N-well structure;

FIG. 4 shows a cross-sectional view of an embodiment of a longitudinal NPN BJT in a triple well of a discharge circuit of the invention;

FIG. 5 shows a top view of an embodiment of the longitudinal NPN BJT of the discharge circuit in the integrated circuit of FIG. 4;

FIG. 6 shows the property of the discharge circuit of the invention;

FIG. 7 shows the simulation relationship between the base voltage and the emitter current in the emitter with the dimension of 2 um*2 um during the 0.18 process of the embodiment of the discharge circuit of the invention;

FIG. 8 shows the simulation relationship between the emitter current and the current gain in the emitter with the dimension of 2 um*2 um during the 0.18 process of the embodiment of the discharge circuit of the invention;

FIG. 9 shows the simulation relationship between the emitter voltage and the emitter current in the emitter with the dimension of 2 um*2 um during the 0.18 process of the embodiment of the discharge circuit of the invention.

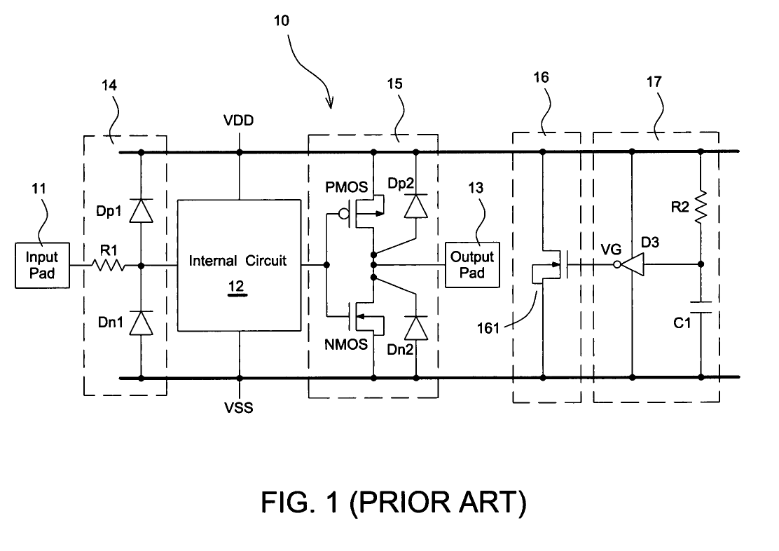

### DETAILED DESCRIPTION OF THE PREFERRED EMBODIMENT

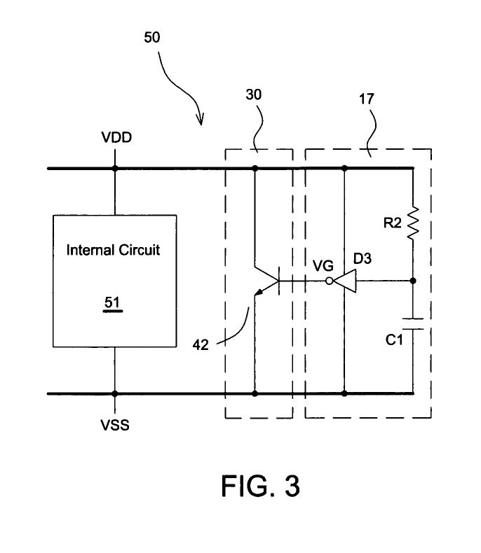

FIG. 3 illustrates an embodiment of an ESD clamp circuit having a deep N-well structure of the invention. Referring to FIG. 3, the ESD clamp circuit 50 of the invention includes a discharge circuit 30 with a deep N-well structure and an ESD detecting unit 17. In the embodiment, the discharge circuit 30 and the ESD detecting unit 17 are applied to an integrated circuit chip and are coupled between a first voltage VDD and a second voltage VSS so as to protect an internal circuit 51 from the ESD damage. The first voltage VDD is positive and the second voltage VSS is ground or negative in this embodiment. The discharge circuit 30 provides a path for the electrostatic discharge so as to bypass the electrostatic charge current when the electrostatic charges surges over the integrated circuit chip. The ESD detecting unit 17 detects the voltage difference between the first voltage VDD and second voltage VSS and generates a trigger signal VG for the discharge circuit 30. Because the ESD detecting unit 17 is a conventional detecting circuit, the detailed descriptions thereof will be omitted.

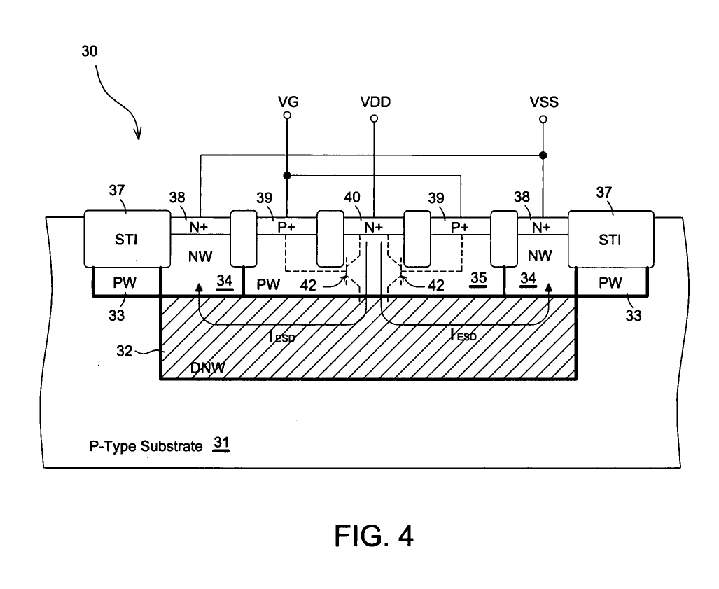

FIG. 4 shows a cross-sectional view of an embodiment of a longitudinal NPN BJT in a triple well of a discharge circuit of the invention. In the embodiment, the discharge circuit 30 is formed with a deep N-well 32 on the P-type substrate 31, a P-well 35 at a substantially central position on the deep N-well 32, and a N-well 34 on the deep N-well 32 surrounding the P-well 35. In addition, a heavily doped N-type region (N+) 40 is formed at a substantially central position on the P-well 35, and a heavily doped P-type region (P+) 39 is formed on the P-well 35 surrounding the heavily doped N-type region 40. Furthermore, a heavily doped N-type region 38 is formed on the N-well 34. The heavily doped N-type region 40 is electrically coupled to the first voltage VDD, the heavily doped N-type region 38 is electrically coupled to the second voltage VSS, and the heavily doped P-type region 39 is electrically coupled to the trigger signal VG Of course, a P-well 33 surrounding the N-well 34 is further formed, and a shallow trench isolation (STI) 37 surrounding the heavily doped N-type region 38 is also formed.

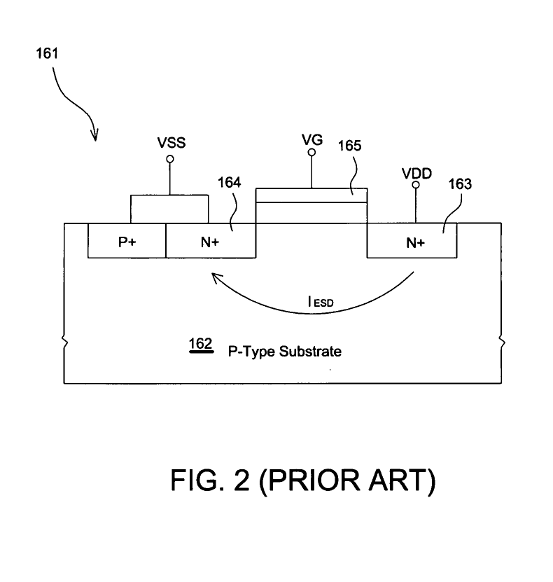

Hence, in the cross-sectional view of the embodiment of the discharge circuit in the integrated circuit of FIG. 4, the heavily doped N-type region 40, the P-well 35, and the deep N-well 32 constitute a longitudinal NPN BJT 42. Consequently, when there are electrostatic charges surged over the pad of the first voltage VDD, the voltage of the trigger signal VG of the ESD detecting unit 17 is increased to turn on the NPN BJT 42, and the electrostatic charge current flows from the pad of the power supply voltage VDD into the pad of the negative power supply voltage VSS through the heavily doped N-type region 40, the P-well 35, the deep N-well 32, the N-well 34, and the heavily doped N-type region 38, and the current is then drained out of the integrated circuit. In a typical discharge circuit (FIG. 2), the electrostatic charge current flows at the transversal direction. In the embodiment, the electrostatic charge current I_{ESD} of the invention flows at the longitudinal direction. Hence, the current gain of the longitudinal NPN BJT 42 of the embodiment is far greater than that of the conventional transistor, and the conventional problems such as poor reliability and the incapability of uniform turn on can be avoided.

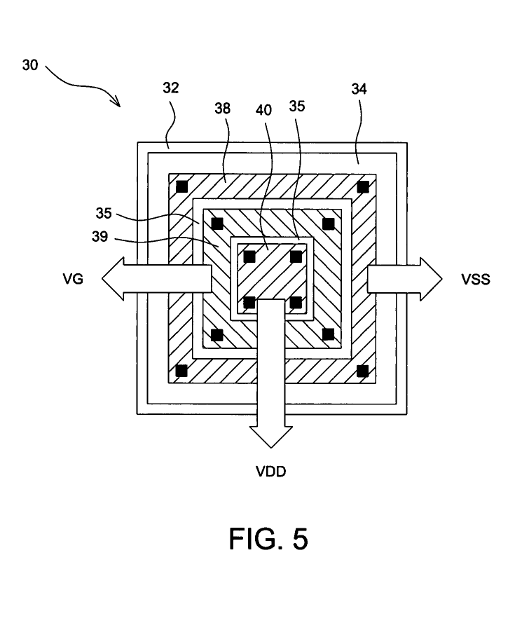

FIG. 5 shows a top view of an embodiment of the longitudinal NPN BJT of the discharge circuit in the integrated circuit of FIG. 4. Referring to FIG. 5, the discharge circuit 30 includes the heavily doped N-type region 40 at the central position, a second layer of heavily doped P-type region 39, and a third layer of heavily doped N-type region 38. The heavily doped N-type region 40 and the second layer of heavily doped P-type region 39 are formed on the P-well 35, while the third layer of heavily doped N-type region 38 is formed on the N-well 34. The N-well 34 and the P-well 35 are formed on the deep N-well 32. It can be understood from FIG. 5 that the heavily doped N-type region 40 is the emitter of the longitudinal NPN BJT 42 and electrically coupled to the first voltage VDD; the second layer of heavily doped P-type region 39 is the base of the longitudinal NPN BJT 42 and electrically coupled to the trigger signal VG; and the third layer of heavily doped N-type region 38 is the source of the longitudinal NPN BJT 42 and electrically coupled to the second voltage VSS. In the structure of FIG. 5, the current gain of the longitudinal NPN BJT 42 of the invention is far greater than that of the conventional transistor.

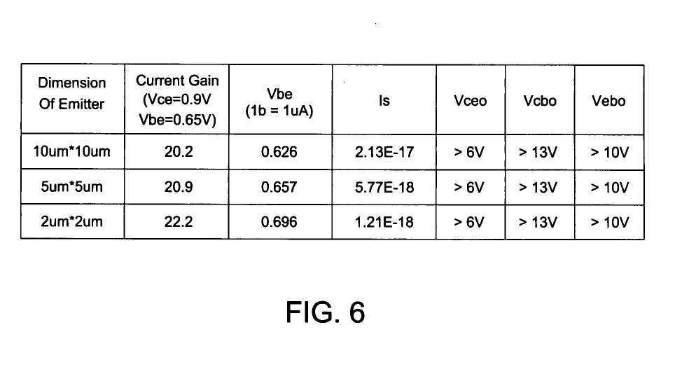

FIG. 6 shows the property of the embodiment discharge circuit of the invention, wherein Is is leakage current, Vceo is the breakdown voltage between the collector and the emitter of the longitudinal NPN BJT, Vcbo is the breakdown voltage between the collector and the base of the longitudinal NPN BJT and Vebo is the breakdown voltage between the emitter and base of the longitudinal NPN BJT. As shown in FIG. 6, the breakdown voltages between the collector, emitter and base of the longitudinal NPN BJT 42 of the invention are greater than 6V, and the current gains thereof are greater than 20. In addition, because the deep N-well isolates the path of the leakage current from the P-type substrate 31, the leakage current of the longitudinal NPN BJT 42 of the invention may be minimized.

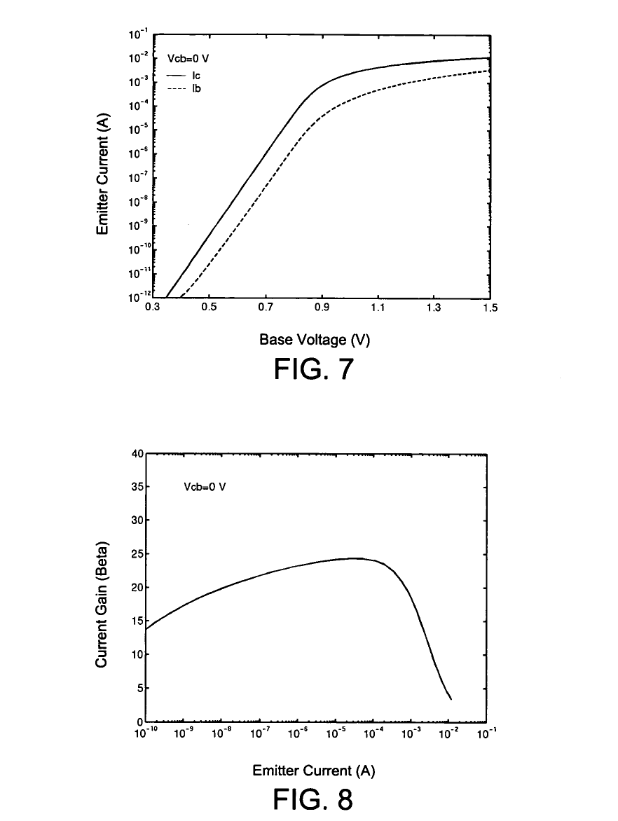

FIG. 7 shows the simulation relationship between the base voltage and the emitter current when the emitter dimension is 2 um*2 um during the 0.18 process of the embodiment of the discharge circuit of the invention, wherein the horizontal axis represents the base voltage in the unit of volt (V) and the vertical axis represents the base current and collector current in the unit of ampere (A). In FIG. 7, the continuous line and the broken line are the collector current and the base current, respectively, and the emitter current is the summation of the collector current and the base current.

FIG. 8 shows the simulation relationship between the emitter current and the current gain when the emitter dimension is 2 um*2 um during the 0.18 process of the embodiment of the discharge circuit of the invention, wherein the horizontal axis represents the emitter current in the unit of ampere (A) and the vertical axis represents the current gain in the unit of Beta. It is noted from the FIG. 8 that the current is greater than 20 when the emitter current is between about 10⁻³ A to 10⁻⁸A.

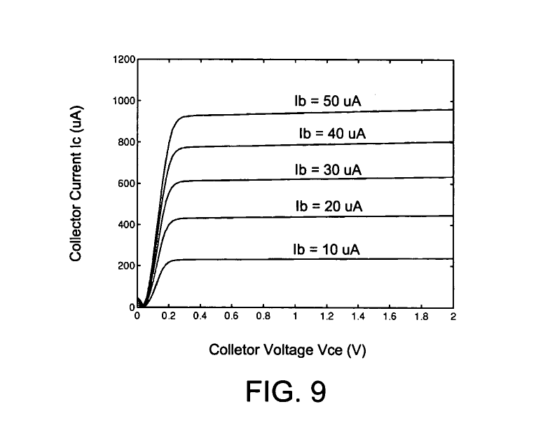

FIG. 9 shows the simulation relationship between the collector voltage and the collector current when the emitter dimension is 2 um*2 um during the 0.18 process of the embodiment of the discharge circuit of the invention, wherein the horizontal axis represents the collector voltage in the unit of volts (V) and the vertical axis represents the collector current Ic in the unit of μA. The base current Ib is between 10 μA to 50 μA step 10 μA.

The ESD clamp circuit having a deep N-well structure is one embodiment of the invention. Of course, the ESD clamp circuit utilities a deep P-well structure can be another embodiment of the invention.

While certain exemplary embodiments have been described and shown in the accompanying drawings, it is to be understood that such embodiments are merely illustrative of and not restrictive on the broad invention, and that this invention not be limited to the specific construction and arrangement shown and described, since various other modifications may occur to those ordinarily skilled in the art.

1. An ESD (ElectroStatic Discharge) clamp circuit coupled between a first voltage and a second voltage, comprising:
an ESD detecting unit for detecting an electrostatic charge between the first voltage and the second voltage and generating a trigger signal; and
a NPN BJT (Bipolar Junction Transistor) triggered by the trigger signal so that an electrostatic charge current flows from the first voltage to the second voltage via the NPN BJT;
wherein the NPN BJT comprises:
a deep N-well formed on a P-type substrate;
a P-well formed on a first part of the deep N-well;
a N-well formed on a second part of the deep N-well;
a first heavily doped N-type region formed on a first part of the P-well and electrically coupled to the first voltage;
a heavily doped P-type region formed on a second part of the P-well and electrically coupled to the trigger signal; and
a second heavily doped N-type region formed on the N-well and electrically coupled to the second voltage.

2. The ESD clamp circuit according to claim 1, wherein the N-well surrounds the P-well.

3. The ESD clamp circuit according to claim 1, wherein the heavily doped P-type region surrounds the first heavily doped N-type region.

4. The ESD clamp circuit according to claim 3, wherein the second heavily doped N-type region surrounds the heavily doped P-type region such that a current gain of the NPN BJT is increased.

5. The ESD clamp circuit according to claim 3, wherein the second heavily doped N-type region surrounds the heavily doped P-type region such that an area of the NPN BJT is reduced.

6. The ESD clamp circuit according to claim 1, wherein the deep N-well isolates the P-well from the P-type substrate such that a leakage current of the NPN BJT is reduced.

7. An ESD (ElectroStatic Discharge) clamp circuit coupled between a first voltage and a second voltage of an integrated circuit, the ESD clamp circuit comprising:
an ESD detecting unit electrically coupled between the first voltage and the second voltage; and
a discharge circuit, comprising a longitudinal NPN BJT (Bipolar Junction Transistor) and located on a P-type substrate, the discharge circuit being electrically coupled between the first voltage and the second voltage;
wherein the longitudinal NPN BJT is driven by the ESD detecting unit and comprises:
a deep N-well formed on the P-type substrate;
a P-well formed on a first part of the deep N-well;
a N-well formed on a second part of the deep N-well;
a first heavily doped N-type region formed on a first part of the P-well and electrically coupled to the first voltage;
a heavily doped P-type region formed on a second part of the P-well and electrically coupled to the trigger signal; and
a second heavily doped N-type region formed on the N-well and electrically coupled to the second voltage.

8. The ESD clamp circuit according to claim 7, wherein the N-well surrounds the P-well.

9. The ESD clamp circuit according to claim 7, wherein the heavily doped P-type region surrounds the first heavily doped N-type region.

10. The ESD clamp circuit according to claim 9, wherein the second heavily doped N-type region surrounds the heavily doped P-type region.

11. The ESD clamp circuit according to claim 7, wherein the first voltage is higher than the second voltage.

12. An ESD (Electrostatic Discharge) clamp circuit connected between a first voltage and a second voltage, the ESD clamp circuit comprising:
an ESD detecting unit connected between the first voltage and the second voltage; and
a longitudinal BJT (bipolar junction transistor) driven by the ESD detecting unit, the longitudinal BJT comprising an emitter which is electronically connected to the first voltage, a collector which is electronically connected to the second voltage, and a base which is coupled to the ESD detecting unit,
wherein the longitudinal BJT in a triple well.

13. The ESD clamp circuit of claim 12, wherein the longitudinal BJT is a longitudinal NPN BJT and is constituted by a N-type region, a P-well, and a deep N-well.

14. The ESD clamp circuit of claim 13, wherein the N-type region is a heavily doped N-type region.

15. The ESD clamp circuit of claim 13, wherein a N-well is formed on the deep N-well, the N-well surrounds the P-well and the P-well surrounds the N-type region such that a current gain of the longitudinal BJT is increased.

16. The ESD clamp circuit of claim 13, wherein the longitudinal BJT is formed on a P-type substrate.

17. The ESD clamp circuit of claim 16, wherein the deep N-well isolates the P-well from the P-type substrate such that a leakage current of the ESD clamp circuit is reduced.
